(19) United States
(12) Patent Application Publication
(10) Pub. No.: US 2020/0388119 A1
(43) Pub. Date: Dec. 10, 2020

(54) SYSTEMS AND METHODS FOR PROTECTING OCCUPANTS FROM AN ATTACK

(71) Applicant: Daniel Allan, Celina, TX (US)

(72) Inventor: Daniel Allan, Celina, TX (US)

(21) Appl. No.: 16/781,967

(22) Filed: Feb. 4, 2020

Related U.S. Application Data
(63) Continuation-in-part of application No. 16/666,942, filed on Oct. 29, 2019.
(60) Provisional application No. 62/801,089, filed on Feb. 4, 2019.

(51) Int. Cl. G08B 7/06; H04W 4/90; H04W 4/021; G08B 15/00

(52) U.S. Cl. CPC G08B 7/06; G08B 15/007; H04W 4/021; H04W 4/90

(57) ABSTRACT

A warning system and deterrence system for attacks on a location is provided, along with the method of warning about and deterring an attack is provided. Other embodiments are also disclosed herein.

### CROSS-REFERENT TO RELATED APPLICATIONS

This application claims the benefit of U.S. Provisional Application No. 62/801,089, filed Feb. 4, 2019 and entitled “Systems and Methods for Protecting Occupants from an Attack,” and U.S. patent application Ser. No. 16/666,942, filed Oct. 29, 2019 and entitled “Systems and Methods for Creating and Identification Signal,” both of which are incorporated herein by reference in their entireties.

### FIELD OF THE INVENTION

The present invention relates generally to systems for protecting occupants of a building or complex from one or more attackers and the methods thereof. More particularly, the present invention relates to systems and methods to stop or hinder an attacker from further advancement.

### BRIEF DESCRIPTION OF THE DRAWINGS

To facilitate further description of the embodiments, the following drawings are provided. The same reference numerals in different figures denote the same elements.

FIG. 1 illustrates an example of an embodiment of a warning system.

FIG. 2 illustrates an example of an embodiment of anti-traction material deterrence.

FIG. 3 illustrates an example of an embodiment of bubble-based deterrence.

FIG. 4 illustrates an example of an embodiment of various deterrence elements.

FIG. 5 illustrates an example of decoy deterrence.

FIG. 6 illustrates a flow chart of a method of warning and deterring an attack, according to at least one embodiment.

### DETAILED DESCRIPTION

There have been many high-profile incidents in which an attacker, quite often a shooter, has attacked an enclosed area, leading to many casualties and/or fatalities. Many of these attacks have occurred in enclosed buildings such as, for example, schools and office buildings. During these attacks, the occupants of the complex are often helpless until law enforcement or other help arrives.

During such attacks, there is a tremendous amount of confusion. Alarms may be sounding, and the occupants don't know if they need to evacuate the building due to an emergency, such as, for example, a fire. Often, the fire alarm may be intentionally activated by the attacker or attackers with the hope of drawing people out of hiding and into common areas.

Therefore, there are benefits to systems and methods that allow for greater occupant safety, by both stopping or slowing the attacker or attackers, and by diminishing the confusion created in such situations, alerting the occupants and first responders as to what is occurring in real time. Such systems and methods can also be considered systems and methods for emergency occupant protection.

In emergency situations, one of the best ways to keep people safe is to have proper alerts. This is true in many situations, such as, for example, weather emergencies and fires. When given the proper warning, the occupants will be enabled to enact their safety protocols. One of the problems during active attacks on the occupants of a building is that there are not proper warning systems. As such, it is often too late to enact the proper protocols in such situations.

Systems and methods according to one or more embodiments of the present invention comprise a warning system to alert the occupants of any premises that an active attacker is present. It should be noted that the premises can comprise a building, campus, office complex, school, or any other building, set of buildings, or area in which people can congregate. The warning system can comprise any combination of sounds and indicators that will allow occupants to know that there is an active attacker, thus allowing proper protocol to be followed.

In one example, the warning system comprises an alarm sound and a signal light that alerts everyone that there is an attacker. Attackers have previously enacted fire alarms in the buildings that they have attacked, trying to lure occupants out into common areas. Therefore, as an example, the warning system alarm sound comprises a sound that is distinct from the fire alarm.

In the same or other examples, the warning system comprises a signal light. As an example, the warning systems signal light can comprise strobe lights. Once again, fire alarms can be accompanied by signal lights. Therefore, the warning system signal light can comprise a visual signal that is distinct from any other alarms, such as, for example, the fire alarm. In one example, the signal light of the warning system can comprise a distinct strobe light.

The warning system can also be used to distract the attacker or attackers. For example, the signal lights can be designed to also distract any attackers, thus making it harder for the attacker or attackers to continue. As one example, the signal light can comprise high intensity strobe lights that can disrupt, confuse, distract, or disorient any attacker. In some examples, the warning system signal light can be separate of additional lights that are used to disrupt, confuse, distract, or disorient any attacker. In such examples, the additional lights can be used only in areas in which the attacker or attackers are present.

Similarly, the warning system alarm sound can also comprise a sound that will disrupt, confuse, distract, or disorient any attacker. In some examples, the warning system alarm sound can be separate of an additional alarm sound that is used to disrupt, confuse, distract, or disorient any attacker. In such examples, the additional alarm sound can be used only in areas in which the attacker or attackers are present.

The warning system can be activated by any known means used to activate such devices, whether now known or developed in the future. One example is a remote-control type device that will activate the warning system alerting people of the attack or pending attack and that the proper protocol (such as sheltering in place) needs to be followed.

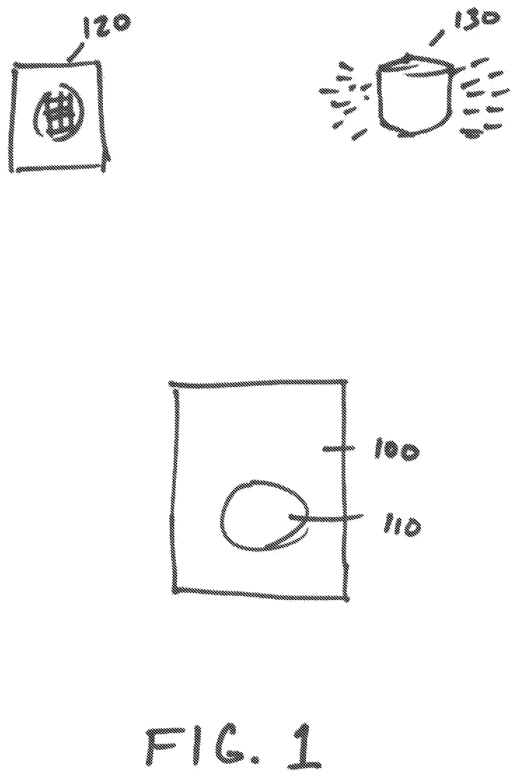

With reference to the figures, FIG. 1 illustrates an example of a remote-control device 100. Device 100 can be considered a warning system activation device. Device 100 includes a button 110. Button 110 can be pressed to activate the warning system. As shown in FIG. 1, once activated, the warning system will play sound over speaker(s) 120 and give out visual signals via strobe light(s) 130.

Device 100 can include additional functions not shown in FIG. 1. For example, there may be a warning system shut off. Options to test the system or just warn via lights or just warn via sound. The device shown in FIG. 1 is, however, simplistic in its design, which would help avoid any difficulties in activating the warning system when an actual attack is occurring. During such an attack, stress levels are high, and having a single button to press will help ensure that the warning system is properly activated.

Device 100 can be connected to the warning system by any proper protocol that allows the connection. As non-limiting examples, the remote can communicate with the warning system via RF, Bluetooth, Wi-Fi, or similar communication protocols.

It should also be noted that the warning system does not need to be activated via device 100. As one example, the warning system can be activated via an app on a smart phone or tablet. As another example, the warning system can be activated by a hardwired button. As yet another example, the warning system can be automatically activated when certain sounds are detected by a sound detection system. For example, if the sound detection system detects a gun shot, the warning system can be activated automatically.

In addition to visual and audio alarms, the warning system can comprise a means for activating a broadcast message to a group of cell phones. This message can come via several different pathways. For example, the message can be an SMS message, audio recording, message through emergency channels, messaging through an app, etc. The message can be broadcast to phones using whatever means available. Furthermore, the group of phones that receives the message can be defined in any number of ways. For example, there can be an opt in, it can go to every cell phone in a certain area using geo-fencing or the like, etc. The message to cell phones can be activated while the other warning systems elements are activated. In addition, the message sent out to the cell phones can include instructions on how to avoid the attacker and/or what protocol to follow.

Systems and methods according to one or more embodiments presented here in may also comprise a safe room. The safe room may be impenetrable by an attacker. As an example, the safe room can be bullet proof and be able to withstand explosions. The safe room will allow an individual or individuals to activate the warning system in complete safety. Furthermore, the safe room will provide the security for an individual to activate various defenses and options presented herein. If a safe room does not exist on the premises, a room can be retrofitted to become a safe room, or an entire safe room can be built. The safe room can comprise all the controls for the systems and methods presented herein.

In addition to a warning system, systems and methods for occupant safety protection presented herein can comprise elements to hinder or stop an attacker from continuing his or her attacks. In some examples, these elements to stop an attack can be considered non-lethal systems and methods to stop an attack, thereby reducing the collateral damage to innocent bystanders.

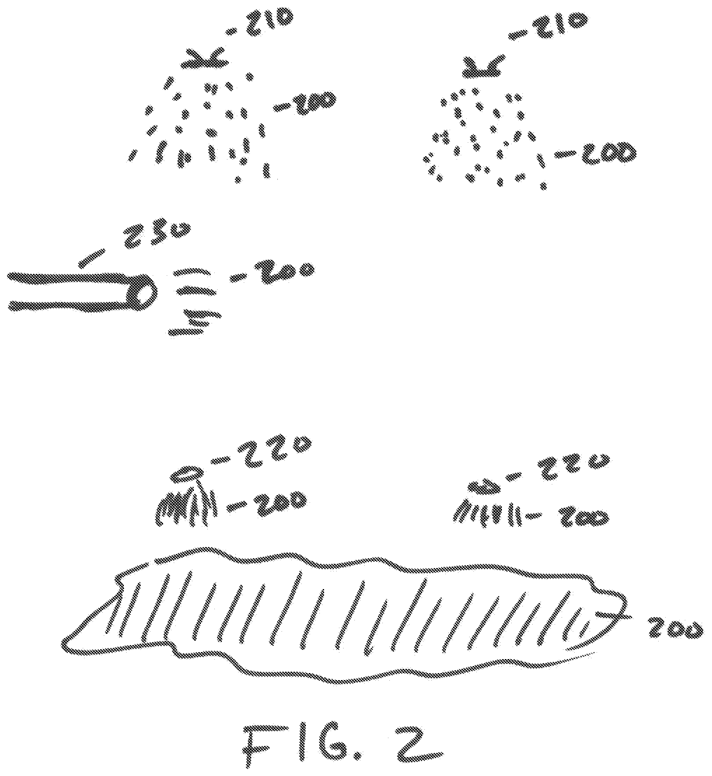

As one example, and with reference to FIG. 2, the systems and methods for occupant safety protection can comprise systems and methods to deploy anti-traction materials. Anti-traction materials are those that will make it difficult, if not impossible, for an assailant to continue with his or her attack. The use of anti-traction materials will make it very difficult or impossible to walk due to the lack of surface coefficient on the floor. Furthermore, the anti-traction materials can make it difficult to fire a weapon due to its slippery characteristics.

FIG. 2 illustrates an example in which an anti-traction material 200 is being deployed into an area. FIG. 2 illustrates three different examples of the deployment of the anti-traction material 200. Ceiling sprinklers 210 are deploying the anti-traction material 200 from a plumbing system in the ceiling. Sprinklers 210 can operate similarly to fire sprinklers. Furthermore, it is also possible for the anti-traction material 200 to be emitted by outlets 220 in the walls. The use of sprinklers 210 or outlets 220 can be activated by the warning system. In other examples, the sprinklers 210 or outlets 220 can be operated by an individual with controls. This can be done, for example, in the safe room mentioned above.

In addition, FIG. 2 illustrates an example where anti-traction material 200 can be distributed manually via a device 230. Device 230 can be the same as or similar to a hose. In other examples, device 230 can be a device that is similar to a gun that distributes anti-traction material 200.

Anti-traction material 200 can comprise any material that creates a situation in which an assailant loses all, or at least a good portion of, his or her traction with the ground. Thus, making it difficult for the assailant to walk and continue with the attack. Examples of an anti-traction material can include those covered by U.S. Pat. Nos. 7,405,184; 7,625,848; 7,419,942; and 7,067,464. In some examples, the anti-traction material 200 can be altered to make it a color that can easily be seen by first responders, allowing those responders to see and avoid material 200.

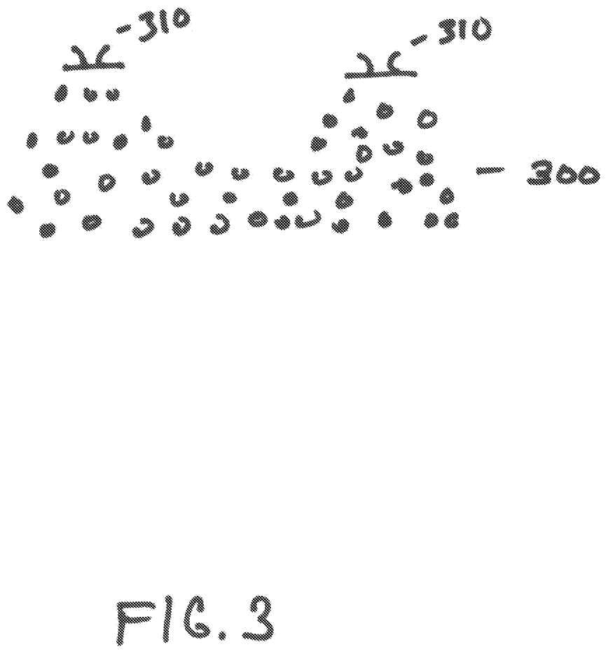

Similar to anti-traction material 200, the systems and methods for occupant safety protection can comprise systems and methods to deploy materials that restrict the field of vision of the assailant or assailants. As one example, systems and methods to deploy bubbles can be used to restrict the field of vision. FIG. 3 illustrates an example of the deployment of bubbles 300. As can be seen in the example of FIG. 3, bubbles 300 are dispersed from sprinklers 310. A huge concentration of bubbles can be dispersed, making it impossible for the assailant or assailants to see anything.

In addition, because bubbles can be easily diluted with water, the concentration of the bubbles can be drastically reduced with the addition of water. Therefore sprinklers 310 (or separate sprinklers not shown herein) can be configured to spray water (with possible chemical additions), thus reducing the concentration of the bubbles and allowing the first responders to access an area that has been concentrated with bubbles.

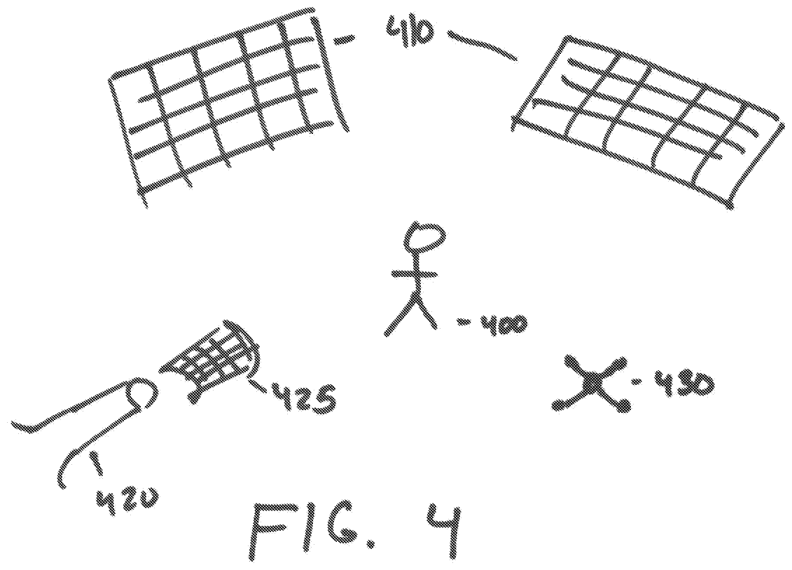

The systems and methods presented herein can also include the use of gates to stop the progress of any assailant. As demonstrated in the example of FIG. 4, gates 410 can be used to stop an assailant 400. The gates can be operated from an individual within a control room, or the gates can be automatically lowered if certain criteria are met. The gates can be used to trap an assailant in a room. In another example, gates can be used to force an assailant into a certain area of a building or complex by only giving the assailant access to certain areas.

In some examples, gates 410 can be motorized gates. In other examples, gates 410 can be spring loaded, and will close once an impediment is removed (by the controls of the system.) In many examples, the gates 410 will close quickly.

With continued reference to FIG. 4, the systems and methods for occupant safety protection can comprise systems and methods to deploy net traps. Net traps can be released onto an assailant, thereby trapping the assailant in a net and not allowing the assailant to move. The example of FIG. 4 illustrates a cannon 420 shooting a net 425. This can be operated, for example, from an individual with controls in the safe room. In another example, there can be a mobile version of a cannon, allowing a first responder to remotely carry a net gun and shoot it when within distance of the assailant.

As another example, the systems and methods for occupant safety protection can comprise the use of a sound cannon. Similar to a net cannon, the sound cannon can be operated from an individual with controls from a safe room. A sound cannon can be activated, severely affecting an assailant. Depending on the severity of the blast, a sound cannon may be able to knock an assailant unconscious, or at the least, severely disorient the assailant.

With continued reference to FIG. 4, the systems and methods for occupant safety protection can also comprise the use of a drone 430. A drone can be launched to track the movement of one or more assailants 400. The drone 430 can relay the position and activity of the assailant 400 to first responders. As with other elements discussed herein, the drone 430 can be controlled by an individual in a safe room. In another example, drone 430 can be controlled directly by first responders. It should be noted that drone 430 (and the other elements mentioned herein) do not have to be controlled within the confines of a safe room. In some examples, there are more than one drone 430 to track the assailant 400. These can be used with each other, or they can be used separately, such as, for examples, in different areas of the building.

In addition to drone 430, a larger drone can be used on the outside of the building or buildings under attack. This drone can be activated to hover over the building, such as a school, for example, to provide first responders with a live feed of the main entrance or any other area that the drone has been directed to cover. The drone (or drones) can be pre-programmed so that stress of flying the drone is not borne by a person under attack. In such an example, a button with a number can simply be pressed, which would will direct the drone to a specific area to cover (correspond to the number pressed.) In another example, the drone may be controlled by a first responder, either on scene or from a remote location. In some examples, the drone will be activated and launched with the activation of the warning system.

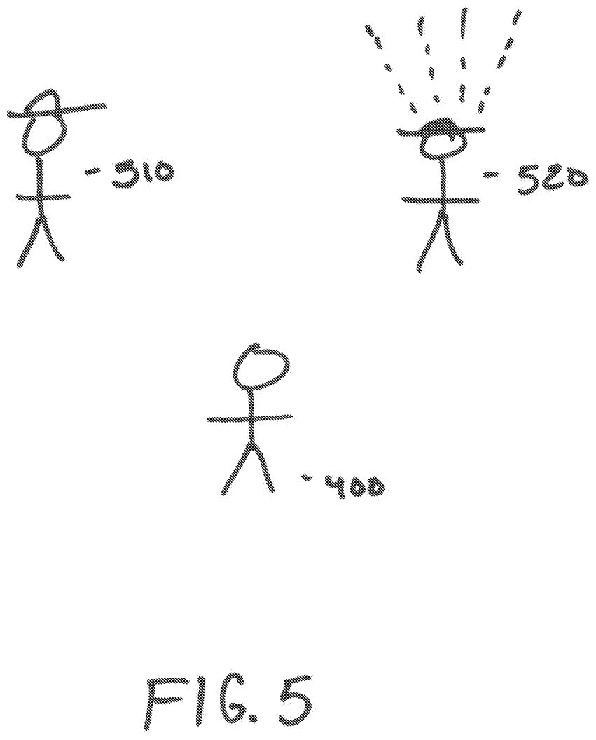

FIG. 5 illustrates the use of decoys to confuse assailants. In the example of FIG. 5 a decoy 510 can be used to confuse the assailant 400. The decoy 510 can be a life size, life-like inanimate figure that is made to replicate the look of an actual police officer at a conspicuous location. This decoy 510 can easily be swapped out for a real human to create uncertainty to any would-be assailants. In the same or other example, the decoy can be a hologram 520. Hologram 520 can be a replica of an actual police officer. Hologram 520 can be activated at various locations to confuse any assailant or to encourage them to stop their attack. In some examples, a voice may be used, either recorded or a live feed used to add realism to the hologram 520 or decoy 510. Hologram 520 can also include recorded or live video, which would allow the hologram to move, replicating a live officer.

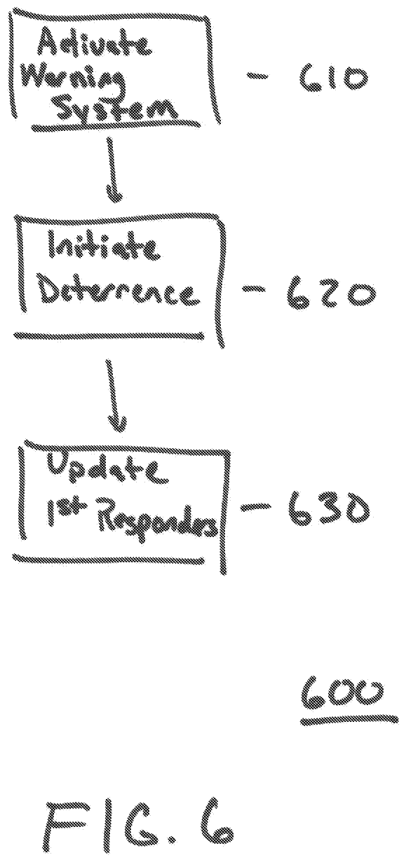

FIG. 6 illustrates an example of a method 600 of deterring an assailant, according to one embodiment. Method 600 can be considered a method of warning and deterring an attack on a building.

Method 600 comprise a procedure 610 of activating a warning system. The activation of the warning system 610 can be activated as discussed with the example of FIG. 1. The warning system can be activated with the remote device 100 of FIG. 1. The warning system can also be activated automatically with the detection of certain sounds, such as, for example, a gunshot.

The activation of warning system 610 can comprise the sounding of alarms, activation of visual lights (such as strobe lights, for example), and the activation of a cell phone message to the cell phones in the area, as discussed above.

Method 600 also comprises a procedure 620 of initiating deterrence measures. As examples, initiating deterrence measures can comprise the examples of FIGS. 2-5. For example, deterrence measures can comprise the use of an anti-traction material (200 from FIG. 2), the use of bubbles (300 from FIG. 3), the use of gates (410 from FIG. 4), the use of a net cannon (420 from FIG. 4), and the use of decoys (510 and 520 from FIG. 5). It should be noted that these are merely examples and other deterrence measures may be taken.

Method 600 further comprises a procedure 630 of updating the first responders. Procedure 630 comprises letting the first responders know what any assailants are doing and the location of any assailants. As an example, procedure 630 can comprise the use of a drone (430 FIG. 4). Furthermore, procedure 630 can also comprise the use of the location bulb described below.

The systems and methods for occupant safety protection can also comprise the use of systems and methods of visual location indication. In some examples, the systems and methods of visual location indication can also be considered a system and method of emergency location indication.

The system and method of emergency location indication (also considered a location bulb) can comprise the use of a light bulb in combination with an application for use on a computer device, such as, for example, a smart phone, tablet, or computer. In one example, the app can be for iOS and Android devices. It should be noted that the light bulb used in the location bulb can comprise elements other than a traditional light bulb. For example, the location bulb can comprise light fixtures, light bulbs, security system lights, doorbells that light up (such as, for example, a smart doorbell), a security light, strobe light, etc. In some examples, the bulb can be considered any internet of things (IOT) device, initiated through an API and/or an SDK software development kit that leverages or is separate from a manufactures app that has the ability to light up. The bulb of the location bulb can comprise any item that can light up, whether now know or hereafter developed.

The systems and methods of the location bulb allow the use of a bulb to indicate where the user is, especially in situations where there is an emergency, such as, for example, a call to 911. As an example, when 911 is dialed on a cell phone with the app installed, it can send a Wi-Fi signal and/or Bluetooth signal to a special bulb that will flash. The activated light can be placed in a conspicuous location either in an interior or exterior placement on a building that will enable a first responder to quickly locate a building or area of a building that a person has dialed 911 and is seeking help. In the example of the systems and methods for occupant safety protection discussed above, once the warning system is activated, a special bulb or bulbs (a strobe light, for example) will be activated in the area of the building in which the activation occurred. As examples, the locator bulb may be used in a school building setting, office building, or warehouse. It may also be suitably designed to work in a residential setting.

As a safety precaution, the location bulb may also be pre-programmed to come on and off at pre-determined times. This can be used similar to lights on a timer, which allows lights to turn on when someone is not home. Furthermore, the bulb that is activated may be of different patterns and different colors, which can be used for different indicators.

The location bulb can be configured to enhance the ability of first responders to locate a home or business in which someone associated with this building has dialed 911 and requires assistance. The light can flash with a defined flash pattern and brightness. Such a visual indicator can help the first responder find the exact location in which an emergency is occurring.

In other examples, the location bulb may also be used by any delivery service. As an example, the location bulb can flash or pulse with a pre-defined, vendor specific flash pattern and/or color pattern, to assist the delivery person locate the delivery destination. The use of this bulb can be linked via an API to an app that is utilized by individual vendors.

As an example, the flash pattern can be activated when a delivery person is within certain distance (such as, for example, a ¼ mile). The app can also notify the customer that the delivery is getting close. Once the delivery has been made, the light can automatically deactivate.

In some examples, if a customer does not have a location bulb, he or she may have the option of using the cell phone as the bulb and the screen (or camera flash) will begin to flash and the customer would either place their phone against a window or door that is visible to the delivery arrival area. In some examples, a special window cradle can be used to hold the phone in order to make the flashing visible to the delivery arrival area.

The API can also be designed to work with home automation systems, such as, for example, Alexa, Google Home, Apple HomeKit, and other internet connected devices to provide audio notifications of the different delivery stages and activate the location bulb.

The software can also be configured to notify the user that the battery is low and needs charging when required. The software can be configured to provide a unique, dynamic code that once used, is replaced with a new and unique code, to prevent hacking.

If a customer has made an order and plans on picking up food, the software may be utilized by a food service company to notify the customer, when the best time to leave and pick up food, so that it at its freshest point, considering the person's relative location in relation to the pickup point.

The software may also be modified and designed to be used by any business (i.e. a doctor's office) to notify customers that their appointment will run late or early. It will give them the option to re-schedule or move to an earlier or later time or keep the current scheduled time.

Although the invention has been described with reference to specific embodiments, it will be understood by those skilled in the art that various changes can be made without departing from the spirit or scope of the invention. Accordingly, the disclosure of embodiments is intended to be illustrative of the scope of the invention and is not intended to be limiting. It is intended that the scope of the invention shall be limited only to the extent required by the appended claims. To one of ordinary skill in the art, it will be readily apparent that the resin product and the methods of creating the same discussed herein may be implemented in a variety of embodiments, and that the foregoing discussion of certain of these embodiments does not necessarily represent a complete description of all possible embodiments. Rather, the detailed description of the drawings, and the drawings themselves, disclose at least one preferred embodiment, and may disclose alternative embodiments.

All elements claimed in any particular claim are essential to the embodiment claimed in that particular claim. Consequently, replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

What is claimed is:

1. A system, comprising:
a warning system; and
deterrence measures;
wherein the warning system comprises strobe lights, audio alarms, and cell phone messaging; and
the deterrence measures comprise the use of an anti-traction material.

2. The system of claim 1, wherein:
the deterrence measures further comprise the use of bubbles.

3. The system of claim 1, wherein:
the deterrence measures further comprise the use of restrictive gates.

4. The system of claim 1, wherein:
the deterrence measures further comprise the use of a net cannon.

5. The system of claim 1; wherein:
the deterrence measures further comprise the use of a sound cannon.

6. The systems of claim 1, wherein:
the deterrence measures further comprise the use of decoys.

7. A system, comprising:
strobe lights;
an anti-traction material; and
a phone messaging system.

8. The system of claim 7, wherein:
the anti-traction material is deposited onto one or more assailants.

9. The system of claim 7; wherein:
the strobe lights disorient one or more assailants.

10. The system of claim 7; wherein:
the phone messaging system alerts a group of cell phones about an emergency at a location.

11. A method, comprising:
activating a warning system;
initiating deterrence measures; and
updating first responders.

12. The method of claim 11, wherein activating a warning system comprise activating a strobe light.

13. The method of claim 11, wherein activating a warning system comprises activating a cell phone messaging system.

14. The method of claim 11, wherein initiating deterrence measures comprises depositing an anti-traction material to deter one or more assailants.
